(19) United States
(12) Patent Application Publication
(10) Pub. No.: US 2025/0348530 A1
(43) Pub. Date: Nov. 13, 2025

(54) TECHNIQUES FOR ENHANCED SEARCHES

(71) Applicant: Apple Inc., Cupertino, CA (US)

(72) Inventor: Aditya Pal, Los Altos, CA (US)

(73) Assignee: Apple Inc., Cupertino, CA (US)

(21) Appl. No.: 19/205,102

(22) Filed: May 12, 2025

Related U.S. Application Data
(60) Provisional application No. 63/646,705, filed on May 13, 2024.

(51) Int. Cl. G06F 16/532; G06F 16/538; G06F 16/55; G06F 16/56

(52) U.S. Cl. CPC G06F 16/532; G06F 16/538; G06F 16/55; G06F 16/56

(57) ABSTRACT

Techniques are disclosed for performing a search of a corpus of data files to identify files that match a query. A file can include metadata and an embedding representing visual characteristics of the data. A semantic understanding model can evaluate the query to identify any entities, locations, actions, and timeframes in the query. A revised query can be produced from the query by removing the identified locations and entities. A semantic search model can use the revised query and the embeddings to identify preliminary files from the corpus of files. The identified locations and entities can be used to filter the preliminary files to identify matching files. The matching files can be presented in a graphical user interface. Implementations of the techniques can include corresponding methods, computer systems, apparatuses, devices, and computer programs recorded on one or more non-transitory computer storage devices.

### CROSS-REFERENCES TO OTHER APPLICATIONS

This application claims priority to U.S. Provisional Application No. 63/646,705, for “TECHNIQUES FOR ENHANCED SEARCHES” filed on May 13, 2024, which is herein incorporated by reference in its entirety for all purposes.

### FIELD

The disclosure relates to techniques for searching unstructured data. Specifically, the disclosure relates to performing searches of a corpus of files.

### BACKGROUND

Mobile device users may generate a corpus of files that includes a large volume of various types of files, including image files or other types of files. These files may include metadata identifying information about when and where the file was created, but there may be little information identifying the content of each file. Accordingly, locating a specific image file within the corpus may require an understanding of when and where that specific file was captured. Thus, improvements to searching a corpus of files are desirable.

### BRIEF SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, the disclosed techniques may include receiving, by an application of a user device, a query associated with a corpus of files, where each file may include metadata and an embedding, and where the embedding represents one or more visual characteristics of the file. The techniques may also include generating, by the application of a user device, a first feature vector for at least a portion of the query, the first feature vector representing one or more textual characteristics of the query. The techniques may furthermore include providing, by the application of the user device, the first feature vector as input to a query understanding model that is trained to semantically parse the first feature vector to identify at least one of one or more entities, one or more locations, one or more actions, or a timeframe. The techniques may in addition include producing, by the application of the user device, a revised query from the query by removing the one or more locations and the timeframe from the query. The techniques may moreover include generating, by the application of the user device, a second feature vector for the revised query. The techniques may also include providing, by the application of the user device, the second feature vector as input to a semantic search model that is trained to compare the second feature vector and the embedding for each file in the corpus of files to identify one or more preliminary files of the corpus of files. The techniques may furthermore include receiving, by the application of the user device, the one or more preliminary files as output from the semantic search model. The techniques may in addition include comparing, by the application of the user device, the one or more locations and the timeframe from the query to the metadata file for each of the one or more preliminary files to identify one or more matching files. The techniques may moreover include presenting, by the application of the user device, at least one of the one or more matching files on a display of the user device. The files can be image files, audio files, video files, word processing files, and spreadsheet files in various implementations of these techniques. Other embodiments of this aspect include corresponding methods, computer systems, apparatus, and computer programs recorded on one or more non-transitory computer storage devices or media, each configured to perform the actions of the techniques.

Implementations may include one or more of the following features. Techniques where providing the first feature vector as input to the query understanding model further may include: classifying, by the application of the user device, the first feature vector as a plain language query or a semantic query; and responsive to classifying the first feature vector as a semantic query, providing, by the application of the user device, the first feature vector as input to the query understanding model. Techniques where producing the revised query may include: comparing, by the application of the user device, each of the one or more entities to a list of unique identifiers to determine one or more matching entities, where a matching entity corresponds to an unique identifier in the list of unique identifiers; and replacing, by the application of the user device, the one or more matching entities with one or more unique identifiers and removing the one or more locations and the timeframe from the query to produce the revised query. Techniques where the one or more matching images may include the one or more preliminary images with metadata that matches at least a location of the one or more locations or the timeframe. Techniques where comparing the one or more locations to the metadata file of a preliminary file may include: identifying one or more distances, each of the one or more distances having a distance between the one or more locations and a metadata location from the metadata file; identifying at least one distance of the one or more distances that has a magnitude that is less than a distance threshold; and classifying the preliminary file as a matching file in response to the at least one distance having a magnitude that is less than the distance threshold. Techniques where comparing the timeframe to the metadata file of a preliminary file may include: identifying a temporal distance having a difference between the timeframe and a metadata timeframe from the metadata file; determining that the temporal distance exceeds a temporal threshold; and classifying the preliminary file as a matching file in response to the temporal distance exceeding the temporal threshold. The files can be image files, audio files, video files, word processing files, and spreadsheet files in various implementations of these techniques. Implementations of the described techniques may include hardware, a method or process, or a non-transitory computer tangible medium.

In one general aspect, the techniques may include receiving a query. The techniques may also include dividing the query into a first part and a second part. The techniques may furthermore include providing the first part as input to a machine learning model that is trained to identify preliminary files by comparing the first part and embeddings for a corpus of files. The techniques may in addition include filtering the preliminary files to identify matching files by comparing the second part and metadata of the preliminary files. The files can be image files, audio files, video files, word processing files, and spreadsheet files in various implementations of these techniques. Other embodiments of these techniques include corresponding methods, computer systems, apparatus, and computer programs recorded on one or more non-transitory computer storage devices or media, each configured to perform the actions of the techniques.

### BRIEF DESCRIPTION

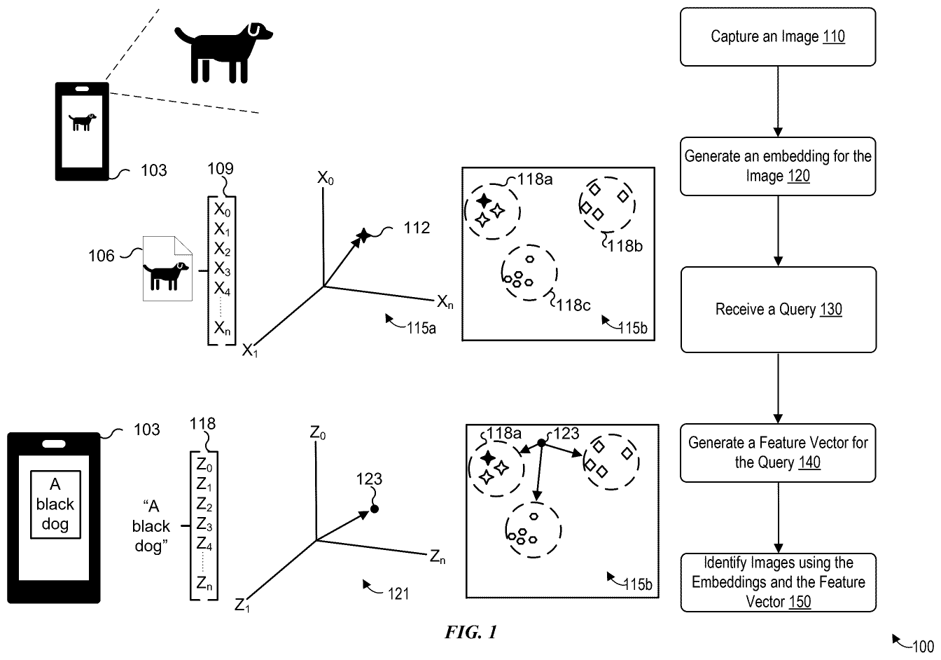

FIG. 1 is a simplified flow chart illustrating a method for performing a search of a corpus of image files according to various embodiments.

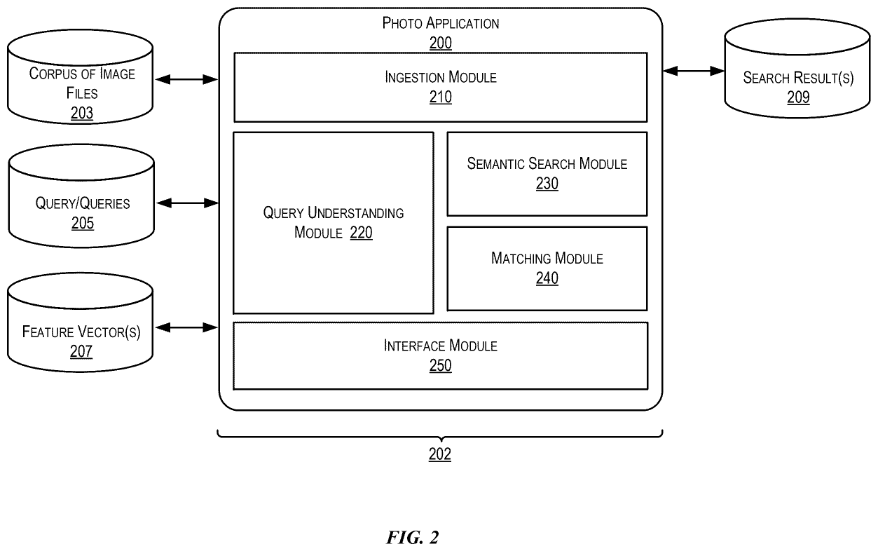

FIG. 2 is an architecture of a photo application for performing a search of a corpus of image files according to various embodiments.

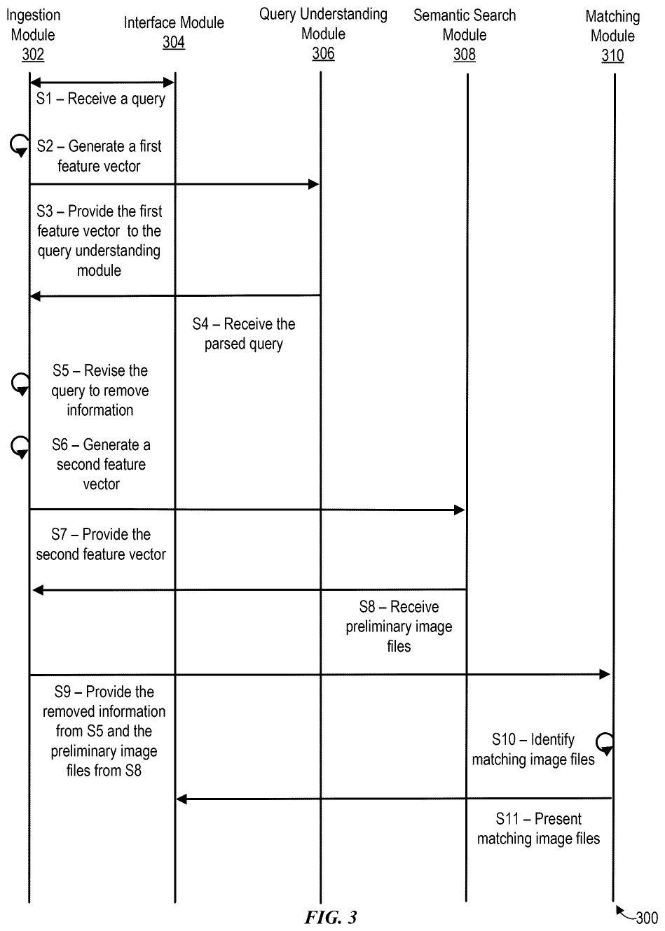

FIG. 3 is a sequence diagram showing a technique for performing a search of a corpus of image files according to various embodiments.

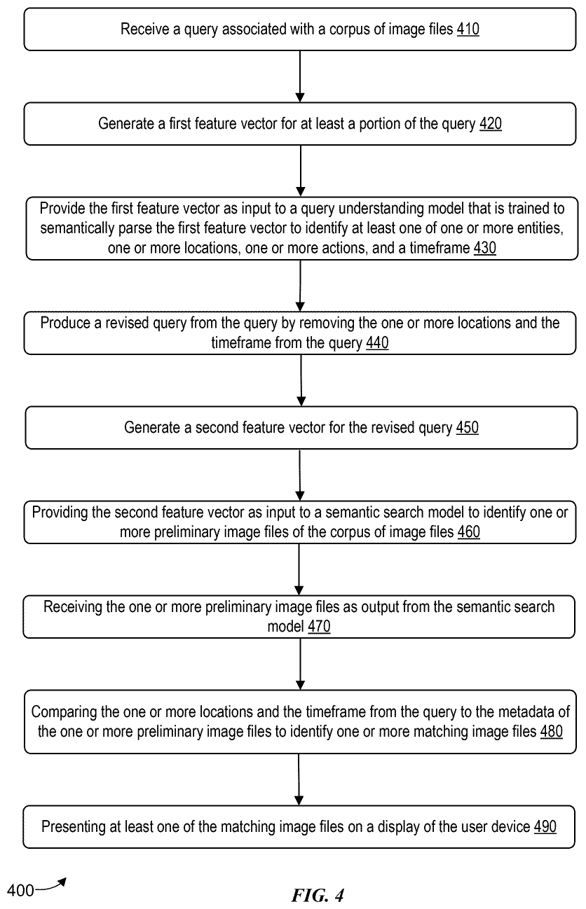

FIG. 4 is a flowchart illustrating a method for performing a search of a corpus of image files according to various embodiments.

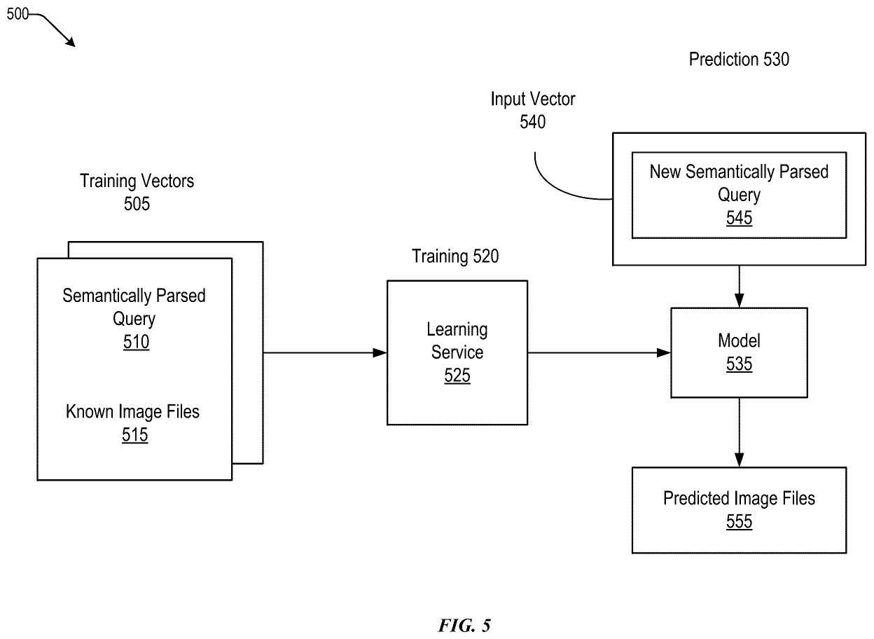

FIG. 5 shows a technique for training a machine learning model according to at least one embodiment.

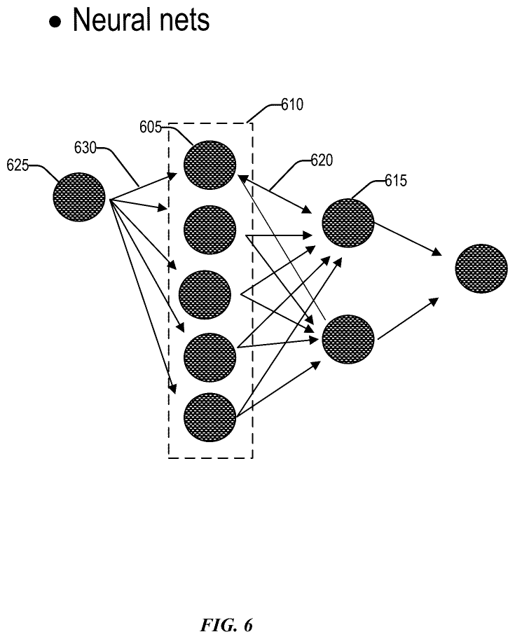

FIG. 6 shows an example machine learning model of a neural network to at least one embodiment.

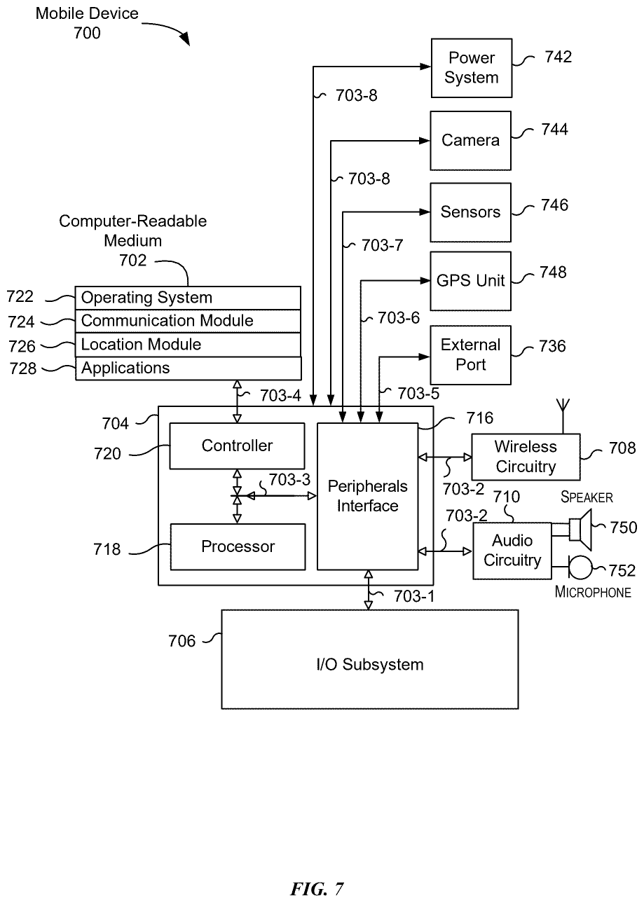

FIG. 7 is a block diagram of an example electronic device according to at least one embodiment.

### DETAILED DESCRIPTION

Certain embodiments are directed to techniques (e.g., a device, a method, a memory or non-transitory computer readable medium storing code or instructions executable by one or more processors) for performing a search of a corpus of unstructured image files.

An application of a user device may store a corpus of data files. The data files in the corpus can include any combination of image files, audio files, video files, word processing files, and spreadsheet files.

In one example, the data files in the corpus can be image files. This corpus can include tens of thousands of images that were acquired over many years. Users often acquire these image files haphazardly and from diverse sources. For example, image files may include pictures from a birthday party, an image of a recipe in a cookbook, a screenshot of a meme, and a filtered selfie that was downloaded from social media. These image files can include metadata with a timestamp recording when the image was generated and information about the location where the image was generated. However, the image files may not provide information about the images' visual content, and, accordingly, the corpus may include an unstructured sequence of images in the order that they were stored to the user device.

The metadata can be used to search for a specific image file; however, such a search may require information about the image that corresponds to the metadata file. For example, a user may need to have an idea about a location or a time when a particular photo was taken to locate the corresponding image file. In such circumstances, a user may have a clear understanding what the particular photo looks like, but the user may struggle to locate the corresponding file in the corpus without knowing when and where the photo was created.

Instead, a device may allow its user to search for an image's visual characteristics by combining metadata and embedding searches. An image file's embedding can be a numeric representation of the visual characteristics of the image (e.g., a feature vector for the image). The mobile device can use information about the pixels in an image file to assign embeddings to that image. These embeddings can be classified by one or more machine learning models to identify visual characteristics of the image, and these visual characteristics can be used to perform semantic searches.

The user device can use embeddings in semantic searches. A keyword search is an attempt to identify labels that match the words in a query. Semantics can refer to techniques to understand the precise meaning of an ordered combination of words, and a semantic search can be a search for results that correspond to the meaning of the query. For example, a keyword search for the query: “a boy holding an orange cat” may return image results showing a boy, oranges, cats, a boy with an orange cat, an orange boy holding a cat, an orange infographic about holding companies, and maybe a boy holding an orange cat. These wide-ranging results are because keyword search techniques match the query's words to labels without interpreting the specific contextual meaning of the words within the query. In contrast, a semantic search may be more likely to return results showing a boy holding an orange cat because the techniques can interpret the linguistic meaning of the query.

Semantics is an attempt to understand the context of an image and glean additional information from the meaning of the image itself (e.g., a word's contextual meaning). A semantic search can provide more precise results because the techniques use a particular interpretation of a query's meaning to perform the search. Every word has multiple possible meanings (e.g., word senses), and keyword search techniques are not capable of identifying a particular combination of word senses for a query. Continuing the example from above, the word senses for orange can include: a color, a fruit, a tree, and a city in France. A keyword search technique would attempt to identify images matching all of these word senses, but a semantic search technique would identify that “a reddish yellow color” is the proper word sense for “orange” as used in the query. Accordingly, semantic searches can be used to obtain more precise search results than a keyword search.

However, semantic searches can be more computationally demanding than keyword searches. In addition, some terms are more suitable for a keyword search. For example, the contextual meaning for a date “May 11, 2024” is unlikely to vary significantly, and, regardless of the position of “May 11, 2024” within a query, the date is likely to refer to a specific time period. Similarly, a proper name for a location (e.g., “San Francisco Bay Area”) is likely to refer to a specific location in most contexts.

Keyword and semantic search techniques can be combined to perform a computationally efficient search that produces accurate results. To perform such a search, the query can be evaluated by a query understanding model to semantically parse the query. After parsing, the query can be revised to remove information that is suitable for a keyword search (e.g., information identifying locations and times), and this revised query can be used to perform a semantic search of the corpus of image files. The semantic search can return preliminary results that are filtered, through a keyword search using the removed information, to identify image files that match the query. These techniques offer a technical advantage of reducing the memory utilization and processing requirements of a semantic search of image files so that the search can be performed by an application of a mobile device.

In an illustrative example, a user of an application of a mobile device can perform a search for the query: “Joey wearing a red shirt during June.” The application provides this query to a query understanding model that parses the query to identify that the query refers to an entity “Joey” who is performing the action “wearing” and the target of the action is a “red shirt.” The query understanding model also determines that “June” refers to a time period, rather than an entity, and this time period modifies the remainder of the query. The application can revise the query to remove the location to produce the revised query “Joey wearing a read shirt.” The revised search can be provided to a semantic search model that identifies preliminary search results from the corpus of image files. These preliminary results can be photos of Joey wearing a red shirt in a variety of time periods. At this point, the application can use the information that was removed from the query to identify a subset of the preliminary results that occurred during June (e.g., the matching results).

Some or all of the process (or any other processes described herein, or variations, and/or combinations thereof) may be performed under the control of one or more computer systems configured with executable instructions and may be implemented as code (e.g., executable instructions, one or more computer programs, or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

FIG. 1 is a simplified flow chart illustrating a method 100 for performing a search of a corpus of image files according to various embodiments. In some implementations, one or more method blocks of FIG. 1 may be performed by a mobile device (e.g., photo application 200, mobile device 700). In some implementations, one or more method blocks of FIG. 1 may be performed by another device or a group of devices separate from or including the mobile device. Additionally, or alternatively, one or more method blocks of FIG. 1 may be performed by one or more components, such as processor 718, computer-readable medium 702, Input/Output (I/O) subsystem 706, wireless circuitry 708, etc.

Turning now to FIG. 1 in greater detail, at block 110, an image can be captured. The image can be captured by mobile device 103, but any suitable computing device or computing system can be used to capture the image. The image can be an image file 106 that is generated by the mobile device 103. The image file 106 may be part of a large corpus of image files that were generated by the mobile device 103, and embeddings may help the mobile device's user to search for specific images within this corpus.

At block 120, an embedding can be generated for the image file. The embedding 109 can be an ordered list of numeric properties that represent information about the image file 106. The terms embedding and feature vector may be used interchangeably in this disclosure, and both terms refer to an ordered list of numeric properties for an entity, object, phrase, etc.

The embedding 109 may be generated by providing the image file 106 as input to a machine learning model that is trained to extract numeric properties from an image. For example, the features can include the color intensity for each pixel in the image, and this information for each pixel may be represented as a first number that represents the pixel's red color intensity, a second number that represents the pixel's green color intensity, and a third number that represents the pixel's blue color intensity.

The model may combine information for groups of pixels, and the combined information may also be recorded in the embedding. The model may use this pixel information to identify features in the image. For example, a change in color intensity between neighboring pixels may indicate the edge of an object. In addition, the embedding may also include nonvisual information about the image file 106, and for example, the embedding may record metadata information about when and where the image file 106 was generated.

The embeddings can help represent information about an image file 106 in a format that allows a computer to group the file with similar images. The embedding 109 is an n-dimensional numeric representation of information about image file 106, and the embedding can be plotted in an n-dimensional space where each axis in this higher dimensional space represents the range of possible values for each embedded property.

The embedding 109 points to a location 112 in this embedded space 115 (e.g., feature space). The coordinates of the location 112 can correspond to the numeric properties for the image file 106, and there may be tens, hundreds, or thousands of axes in the embedded space 115. FIG. 1 includes simplified embedded space representations with reduced dimensionality, and, for example, embedded space 115a is a three-dimensional representation of the embedded space and embedded space 115b is a two-dimensional representation of the embedded space.

Embeddings for the image files in the corpus of images may be plotted in the embedded space, and this can be used to identify similar image files. Image files that are close in embedded space may be similar, and image files that are plotted in different parts of embedded space may not be similar. Proximity in image space can be used to identify clusters of related image files 118a-118c.

At block 130, a query can be received at the mobile device 103. The image captured at block 110 can be a representation of a black dog, and the query may be a request for “a black dog.”

At block 140, a feature vector can be generated for the query. The feature vector 118 can represents the query's textual characteristics in feature space 121. The feature vector 118 may include one or more numeric values that represent each word in the query, the semantic relationships between words, and the role of each word in the query.

At block 150, images that are relevant to the query can be identified using the embeddings and the feature vectors. A machine learning model may be trained to identify appropriate image embeddings for a given query feature vector. The properties of the feature vectors and the embeddings can be aligned by adjusting the model's weights and parameters until the model returns appropriate embeddings in response to a given feature vector. The trained model can plot the feature vector at location 123 in the two-dimensional embedded space representation 115b. The model can identify cluster 118a as containing images that are related to the query because these images' embedded space representations are close to location 123.

FIG. 2 is a schematic diagram of an example computer architecture for the photo application 200, including a plurality of modules that may perform functions in accordance with at least one embodiment. The modules may be software modules, hardware modules, or a combination thereof. If the modules are software modules, the modules can be embodied on a computer readable medium and processed by a processor in any of the computer systems described herein. It should be noted that any module or data store described herein, may be, in some embodiments, be a service responsible for providing functionality corresponding to the module described below. The modules 202 may be execute as part of the photo application 200, or the modules 202 may exist as separate modules or services external to the photo application 200. In some embodiments, the modules 202 may be executed by the same or different computing devices, as a service, as an application, or the like.

In the embodiment shown in the FIG. 2, data stores such as corpus of image files 203, query/queries 205, feature vectors 207, and search result(s) 209 are shown, although data can be maintained, derived, or otherwise accessed from various data stores, either remote or local to the photo application 200, to achieve the functions described herein. The image files can be any type of data files in various embodiments. For example, the data files can be any combination of audio files, image files, video files, word processing files, and spreadsheet files. The photo application 200, as shown in FIG. 2, includes various modules such as an ingestion module 210, a query understanding module 220, a semantic search module 230, a matching module 240 and an interface module 250. Some functions of the modules 210-150 are described below. However, for the benefit of the reader, a brief, non-limiting description of each of the modules is provided in the following paragraphs. In accordance with at least one embodiment, a process for performing a search of a corpus of image files is provided.

In at least one embodiment, the photo application 200 (e.g., the application) includes the ingestion module 210. Generally, the ingestion module 210 may receive queries 205, generate feature vectors 207, and manage the flow of information between the modules 202. The ingestion module can receive a query 205 from the interface module 250. For example, the feature vector for a query can be any combination of an ordered list of numbers representing the individual characters in the query 205, or an ordered list of numbers representing the individual words in the query 205. The ingestion module 210 may modify the query to remove one or more words or characters. In some embodiments, the ingestion module 210 may revise the query by revising the query's feature vector to generate a second feature vector. In some embodiments, the ingestion module 210 may revise the query by revising the output of the query understanding module 220 to generate a second feature vector.

In at least one embodiment, the photo application 200 (e.g., the application) includes the query understanding module 220. Generally, the query understanding module 220 can semantically parse a feature vector 207 representing a query 205. The query understanding module 220 may parse the feature vector 207 to identify one or more entities (e.g., humans, animals, objects, etc.), one or more locations, one or more actions, or a timeframe. The actions can disambiguate a relationship between the identified entities or otherwise provide context for to the entities. The query understanding module 220 can include a trained machine learning model that is trained to perform natural language processing techniques to semantically parse a query.

In at least one embodiment, the photo application 200 (e.g., the application) includes the semantic search module 230. Generally, the semantic search module 230 can use a feature vector to identify one or more preliminary image files (e.g., search results 209). The feature vector can be an ordered sequence of numbers representing at least a portion of a semantically parsed query produced by the query understanding module 220. The feature vector may include information identifying the words in the query, one or more linguistic labels for the words, and the relationships between these words. The semantic search module 230 can identify the preliminary search results 209 by comparing the feature vector to the embeddings of the image files in the corpus of image files 203. The semantic search module 230 can be implemented as a trained machine learning model as described herein.

In at least one embodiment, the photo application 200 (e.g., the application) includes the matching module 240. Generally, the matching module 240 can identify matching image files from the preliminary image files. The matching module 240 can identify the matching image files by comparing any combination of locations and timeframes identified by the query understanding module 220 against the metadata of the preliminary image files. The matching image files can be the preliminary image files that contain metadata corresponding to the locations or timeframes.

In at least one embodiment, the photo application 200 (e.g., the application) includes the interface module 250. Generally, the interface module 250 can receive input and provide output. For example, the interface module 250 can receive a query from one or more Input/Output (I/O) subsystems. The I/O subsystems can be a display device and the interface module 250 may provide a graphical user interface for receiving queries 205 and presenting search result(s) 209. The search results 209 can include any of the corpus of image files 203 including preliminary image files and matching image files.

FIG. 3 is a sequence diagram 300 showing a technique for performing a search of a corpus of image files according to various embodiments. The image files can be any type of data files in various embodiments. For example, the data files can be any combination of audio files, image files, video files, word processing files, and spreadsheet files. At S1, a query can be received at the ingestion module 302 from the interface module 304. The query can be received via a graphical user interface displayed by the interface module 304. The query can be a request for one or more image files in a corpus of image files. Each image file may include metadata and one or more embeddings representing the visual characteristics of the image files.

At S2, the ingestion module 302 can generate a first feature vector. The first feature vector can be an ordered sequence of numeric values representing the textual characteristics of the query from S1.

At S3, the ingestion module 302 can provide the first feature vector from S2 to the query understanding module 306. The query understanding module 306 can provide the feature vector from S2 as input to a trained machine learning model.

At S4, the ingestion module 302 can receive the parsed query from the query understanding module 306. The query understanding module 306 can receive the parsed query as output from the machine learning model from S3.

At S5, the ingestion module 302 can revise the parsed query from S4 to remove locations and timeframes (e.g., the removed information).

At S6, the ingestion module 302 can generate a second feature vector from the revised query from S5. In some embodiments, the ingestion module 302 can generate the second feature vector by revising the first feature vector from S2.

At S7, the ingestion module 302 can provide the second feature vector from S6 to the semantic search module 308. The semantic search module 308 can provide the second feature vector as input to a trained machine learning model that compares the second feature vector to embeddings for the image files in the corpus of image files from S1.

At S8, the ingestion module 302 can receive preliminary image files from the semantic search module 308. The preliminary image files can be image files that the model in the semantic search module 308 classified as having embeddings that are similar to the second feature vector from S6.

At S9, the ingestion module 302 can provide the removed information from S5 and the preliminary image files from S8 to the matching module 310.

At S10, the matching module 310 can compare the removed information from S5 against the metadata for preliminary image files from S8 to identify matching image files. In some embodiments, an image file may match the removed information if a location for the image file is within a threshold distance of a location from the removed information. In some embodiments, an image file may match the removed information if a timestamp for the image file is within a threshold amount of time of a timeframe from the removed information.

At S11, the interface module 304 can receive the matching image files from the matching module 310 and present the matching image files. The matching image files can be presented on an I/O subsystem of a device executing the instructions of sequence 300.

FIG. 4 is a flowchart illustrating a method 400 for performing a search of a corpus of image files according to various embodiments. The image files can be any type of data files in various embodiments. For example, the data files can be any combination of audio files, image files, video files, word processing files, and spreadsheet files. In some implementations, one or more method blocks of FIG. 4 may be performed by a mobile device (e.g., photo application 200, mobile device 700). In some implementations, one or more method blocks of FIG. 4 may be performed by another device or a group of devices separate from or including the mobile device. Additionally, or alternatively, one or more method blocks of FIG. 4 may be performed by one or more components, such as processor 718, computer-readable medium 702, Input/Output (I/O) subsystem 706, wireless circuitry 708, etc.

At block 410, a query associated with a corpus of image files can be received by an application of a user device. The application can be photo application 200 and the user device can be electronic device 700. Each image file can include metadata and an embedding. An embedding can be information that represents one or more visual characteristics of the image file. In some embodiments, the embedding can include information that represents one or more textual characteristics of written text that appears in the image file.

At block 420, a first feature vector can be generated for at least a portion of the query. The feature vector can represent the textual characteristics of the query. The textual characteristics can be an ordered sequence of the characters in the query. The first feature vector may be provided to a trained model or compared to one or more rules to classify the query as a plain language query (e.g., a keyword search query) or a semantic query. The first feature vector may be provided to the query understanding model if the query is classified as a semantic query.

At block 430, the first feature vector can be provided as input to a query understanding model. The query understanding model can be trained to semantically parse the feature vector to identify at least one or more entities, one or more locations, one or more actions, or a timeframe. Entities can be an object, a person, or an animal. A timeframe can be a date, a time, a season, a holiday, or any other information identifying a range of time. Actions can be any information that represents a relationship between any two entities or that modifies an entity. A location can be coordinates, a proper name of a location, or any other information that can be used to identify a location (e.g., “home”). The input first feature vector can be classified by the application as a plain language query or a semantic query. The first feature vector can be provided as input to the query understanding model in response to the vector being classified as a semantic query.

At block 440, a revised query can be produced from the query from block 410 by removing any identified locations and timeframes that were identified by the semantic understanding model at block 430. The revised query can be produced by modifying the first feature vector from block 420. Revising the query may include comparing any entities to a list of unique identifiers to determine if the entity corresponds to an identifier (e.g., is a matching entity). If a matching entity is identified, the entity in the query can be replaced by the unique identifier.

At block 450, a second feature vector can be produced for the revised query from block 440. In some embodiments, the second feature vector can be produced from the first feature vector from block 420.

At block 460, the second feature vector from block 450 can be provided as input to a semantic search model. The semantic search model can be trained to compare the second feature vector and the embedding for each image file in the corpus of image files from block 410 to identify one or more preliminary image files of the corpus of image files. To identify the preliminary image files, the embeddings for each image file in the corpus of image files can be compared to the second feature vector.

At block 470, the one or more preliminary image files can be received as output from the semantic search model from block 460.

At block 480, the removed locations and timeframe from block 440 can be compared to the metadata for each of the preliminary image files from block 470 to identify one or more matching image files. A matching image file can be an image file that includes a location or a timeframe from block 440. The metadata for the preliminary image files may be used to identify one or more distances representing a distance between the locations from block 440 and a location identified in the metadata (a metadata location). If these distances have a magnitude that is less than a distance threshold, then the corresponding image file can be classified as a matching image file. The metadata for the preliminary image files may be used to identify a temporal distance representing a difference between the timeframe from block 440 and information identifying a time when an image file was generated (a metadata timeframe). If the temporal distance has a magnitude that is less than a temporal threshold, then the corresponding image file can be classified as a matching image file.

At block 490, the matching image files from block 480 can be presented on a display of the user device implementing the disclosed techniques.

Method 400 may include additional implementations, such as any single implementation or any combination of implementations described below and/or in connection with one or more other processes described elsewhere herein.

Although FIG. 4 shows example blocks of method 400, in some implementations, method 400 may include additional blocks, fewer blocks, different blocks, or differently arranged blocks than those depicted in FIG. 4. Additionally, or alternatively, two or more of the blocks of method 400 may be performed in parallel.

FIG. 5 depicts an architecture for training a machine learning model according to the embodiments of the present disclosure. Training vectors 505 are shown with a semantically parsed query 510 and known image files 515. The image files can be any type of data files in various embodiments. For example, the data files can be any combination of audio files, image files, video files, word processing files, and spreadsheet files. For ease of illustration, only two training vectors are shown, but the number of training vectors may be much larger, e.g., 10, 50, 100, 1,000, 10,000, 100,000, or more. Training vectors could be made for different physical environments, the same physical environment over different time periods.

Semantically parsed query 510 have property fields that can correspond to the output of the query understanding module and the skilled person will appreciate the various ways that such sensor values can be configured. Known image files 515 include image files that have been identified to correspond to the semantically parsed query 510. For example, the known image files 515 that were identified as corresponding to the semantically parsed query 510. For example, a human may manually identify and label the known image files 515 as corresponding to the semantically parsed query 510. The training vector 505 can include at least one known image file 515 and the semantically parsed query 510 that correspond to those image files.

Training vectors 505 can be used by a learning service 525 to perform training 520. A service, such as learning service 525, being one or more computing devices configured to execute computer code to perform one or more operations that make up the service. Learning service 525 can optimize parameters of a model 535 such that a quality metric (e.g., accuracy of model 535) is achieved with one or more specified criteria. The accuracy may be measured by comparing known image files 515 to predicted image files 555. Parameters of model 535 can be iteratively varied to increase accuracy. Determining a quality metric can be implemented for any arbitrary function including the set of all risk, loss, utility, and decision functions.

In some embodiments of training, a gradient may be determined for how varying the parameters affects a cost function, which can provide a measure of how accurate the current state of the machine learning model is. The gradient can be used in conjunction with a learning step (e.g., a measure of how much the parameters of the model should be updated for a given time step of the optimization process). The parameters (which can include weights, matrix transformations, and probability distributions) can thus be optimized to provide an optimal value of the cost function, which can be measured as being above or below a threshold (i.e., exceeds a threshold) or that the cost function does not change significantly for several time steps, as examples. In other embodiments, training can be implemented with methods that do not require a hessian or gradient calculation, such as dynamic programming or evolutionary algorithms.

A prediction stage 530 can provide a predicted image files 555 for a new entity's entity signature vector 540 based on a new semantically parsed q uery 545. The predicted image files 555 can be a image file that corresponds to the input vector 540. The new semantically parsed query can be of a similar type as semantically parsed query 510. If new semantically parsed queries are of a different type, a transformation can be performed on the data to obtain data in a similar format as semantically parsed query 510. Ideally, predicted image files 555 corresponds to the desired image files for input vector 540.

A “machine learning model” (ML model) can refer to a software module configured to be run on one or more processors to provide a classification or numerical value of a property of one or more samples. An ML model can be generated using sample data (e.g., training data) to make predictions on test data. One example is an unsupervised learning model. Another example type of model is supervised learning that can be used with embodiments of the present disclosure. Example supervised learning models may include different approaches and algorithms including analytical learning, statistical models, artificial neural network, backpropagation, boosting (meta-algorithm), Bayesian statistics, case-based reasoning, decision tree learning, inductive logic programming, Gaussian process regression, genetic programming, group method of data handling, kernel estimators, learning automata, learning classifier systems, minimum message length (decision trees, decision graphs, etc.), multilinear subspace learning, naive Bayes classifier, maximum entropy classifier, conditional random field, nearest neighbor algorithm, probably approximately correct learning (PAC) learning, ripple down rules, a knowledge acquisition methodology, symbolic machine learning algorithms, subsymbolic machine learning algorithms, minimum complexity machines (MCM), random forests, ensembles of classifiers, ordinal classification, data pre-processing, handling imbalanced datasets, statistical relational learning, or Proaftn, a multicriteria classification algorithm. The model may include linear regression, logistic regression, deep recurrent neural network (e.g., long short term memory, LSTM), hidden Markov model (HMM), linear discriminant analysis (LDA), k-means clustering, density-based spatial clustering of applications with noise (DBSCAN), random forest algorithm, support vector machine (SVM), or any model described herein. Supervised learning models can be trained in various ways using various cost/loss functions that define the error from the known label (e.g., least squares and absolute difference from known classification) and various optimization techniques, e.g., using backpropagation, steepest descent, conjugate gradient, and Newton and quasi-Newton techniques.

Examples of machine learning models include deep learning models, neural networks (e.g., deep learning neural networks), kernel-based regressions, adaptive basis regression or classification, Bayesian methods, ensemble methods, logistic regression and extensions, Gaussian processes, support vector machines (SVMs), a probabilistic model, and a probabilistic graphical model. Embodiments using neural networks can employ using wide and tensorized deep architectures, convolutional layers, dropout, various neural activations, and regularization steps.

FIG. 6 shows an example machine learning model of a neural network. As an example, model 635 can be a neural network that comprises a number of neurons (e.g., Adaptive basis functions) organized in layers. For example, neuron 605 can be part of layer 610. The neurons can be connected by edges between neurons. For example, neuron 605 can be connected to neuron 615 by edge 620. A neuron can be connected to any number of different neurons in any number of layers. For instance, neuron 605 can be connected to neuron 625 by edge 630 in addition to being connected to neuron 615.

The training of the neural network can iteratively search for the best configuration of the parameter of the neural network for feature recognition and prediction performance. Various numbers of layers and nodes may be used. A person with skills in the art can easily recognize variations in a neural network design and design of other machine learning models. For example, neural networks can include graph neural networks that are configured to operate on unstructured data. A graph neural network can receive a graph (e.g., nodes connected by edges) as an input to the model and the graph neural network can learn the features of this input through pairwise message passing. In pairwise message passing, nodes exchange information and each node iteratively updates its representation based on the passed information. More detail about graph neural networks can be found in the following reference: Wu, Zonghan, et al. “A comprehensive survey on graph neural networks.” IEEE transactions on neural networks and learning systems 32.1 (2020): 8-2 8.

FIG. 7 is a block diagram of an example electronic device 700 according to various embodiments. Device 700 generally includes computer-readable medium 702, a processing system 704, an Input/Output (I/O) subsystem 706, wireless circuitry 708, and audio circuitry 710 including speaker 712 and microphone 714. These components may be coupled by one or more communication buses or signal lines 703. Device 700 can be any portable electronic device, including a handheld computer, a tablet computer, a mobile phone, laptop computer, tablet device, media player, personal digital assistant (PDA), a key fob, a car key, an access card, a multifunction device, a mobile phone, a portable gaming device, a headset, or the like, including a combination of two or more of these items.

it should be apparent that the architecture shown in FIG. 7 is only one example of an architecture for device 700, and that device 700 can have more or fewer components than shown, or a different configuration of components. The various components shown in FIG. 7 can be implemented in hardware, software, or a combination of both hardware and software, including one or more signal processing and/or application specific integrated circuits.

Wireless circuitry 708 is used to send and receive information over a wireless link or network to one or more other devices' conventional circuitry such as an antenna system, a radio frequency (RF) transceiver, one or more amplifiers, a tuner, one or more oscillators, a digital signal processor, a coder-decoder (CODEC) chipset, memory, etc. Wireless circuitry 708 can use various protocols, e.g., as described herein. In various embodiments, wireless circuitry 708 is capable of establishing and maintaining communications with other devices using one or more communication protocols, including time division multiple access (TDMA), code division multiple access (CDMA), global system for mobile communications (GSM), Enhanced Data GSM Environment (EDGE), wideband code division multiple access (W-CDMA), Long Term Evolution (LTE), LTE-Advanced, Wi-Fi (such as Institute of Electrical and Electronics Engineers (IEEE) 902.11a, IEEE 902.11b, IEEE 902.11g and/or IEEE 902.11n), Bluetooth, Wi-MAX, Voice Over Internet Protocol (VOIP), near field communication protocol (NFC), a protocol for email, instant messaging, and/or a short message service (SMS), or any other suitable communication protocol, including communication protocols not yet developed as of the filing date of this document.

Wireless circuitry 708 is coupled to processing system 704 via peripherals interface 716. Peripherals interface 716 can include conventional components for establishing and maintaining communication between peripherals and processing system 704. Voice and data information received by wireless circuitry 708 (e.g., in speech recognition or voice command applications) is sent to one or more processors 718 via peripherals interface 716. One or more processors 718 are configurable to process various data formats for one or more application programs 734 stored on medium 702.

Peripherals interface 716 couple the input and output peripherals of device 700 to the one or more processors 718 and computer-readable medium 702. One or more processors 718 communicate with computer-readable medium 702 via a controller 720. Computer-readable medium 702 can be any device or medium that can store code and/or data for use by one or more processors 718. Computer-readable medium 702 can include a memory hierarchy, including cache, main memory and secondary memory. The memory hierarchy can be implemented using any combination of random access memory (RAM) (e.g., static random access memory (SRAM,) dynamic random access memory (DRAM), double data random access memory (DDRAM)), read only memory (ROM), FLASH, magnetic and/or optical storage devices, such as disk drives, magnetic tape, CDs (compact disks) and DVDs (digital video discs). In some embodiments, peripherals interface 716, one or more processors 718, and controller 720 can be implemented on a single chip, such as processing system 704. In some other embodiments, they can be implemented on separate chips.

Processor(s) 718 can include hardware and/or software elements that perform one or more processing functions, such as mathematical operations, logical operations, data manipulation operations, data transfer operations, controlling the reception of user input, controlling output of information to users, or the like. Processor(s) 718 can be embodied as one or more hardware processors, microprocessors, microcontrollers, field programmable gate arrays (FPGAs), application-specified integrated circuits (ASICs), or the like.

Device 700 also includes a power system 742 for powering the various hardware components. Power system 742 can include a power management system, one or more power sources (e.g., battery, alternating current (AC)), a recharging system, a power failure detection circuit, a power converter or inverter, a power status indicator (e.g., a light emitting diode (LED)) and any other components typically associated with the generation, management and distribution of power in mobile devices.

In some embodiments, device 700 includes a camera 744. In some embodiments, device 700 includes sensors 746. Sensors can include accelerometers, compass, gyrometer, pressure sensors, audio sensors, light sensors, barometers, and the like. Sensors 746 can be used to sense location aspects, such as auditory or light signatures of a location.

In some embodiments, device 700 can include a GPS receiver, sometimes referred to as a GPS unit 748. A mobile device can use a satellite navigation system, such as the Global Positioning System (GPS), to obtain position information, timing information, altitude, or other navigation information. During operation, the GPS unit can receive signals from GPS satellites orbiting the Earth. The GPS unit analyzes the signals to make a transit time and distance estimation. The GPS unit can determine the current position (current location) of the mobile device. Based on these estimations, the mobile device can determine a location fix, altitude, and/or current speed. A location fix can be geographical coordinates such as latitudinal and longitudinal information.

One or more processors 718 run various software components stored in medium 702 to perform various functions for device 700. In some embodiments, the software components include an operating system 722, a communication module 724 (or set of instructions), a location module 726 (or set of instructions), and other application programs 728 (or set of instructions).

Operating system 722 can be any suitable operating system, including iOS, Mac OS, Darwin, Real Time Operating System (RTXC), LINUX, UNIX, OS X, WINDOWS, or an embedded operating system such as VxWorks. The operating system can include various procedures, sets of instructions, software components and/or drivers for controlling and managing general system tasks (e.g., memory management, storage device control, power management, etc.) and facilitates communication between various hardware and software components.

Communication module 724 facilitates communication with other devices over one or more external ports 736 or via wireless circuitry 708 and includes various software components for handling data received from wireless circuitry 708 and/or external port 736. External port 736 (e.g., universal serial bus (USB), Fire Wire, Lightning connector, 70-pin connector, etc.) is adapted for coupling directly to other devices or indirectly over a network (e.g., the Internet, wireless local area network (LAN), etc.).

Location module 726 can assist in determining the current position (e.g., coordinates or other geographic location identifiers) and motion of device 700. Modern positioning systems include satellite based positioning systems, such as Global Positioning System (GPS), cellular network positioning based on “cell IDs,” and Wi-Fi positioning technology based on a Wi-Fi networks. GPS also relies on the visibility of multiple satellites to determine a position estimate, which may not be visible (or have weak signals) indoors or in “urban canyons.” In some embodiments, location/motion module 726 receives data from GPS unit 748 and analyzes the signals to determine the current position of the mobile device. In some embodiments, location/motion module 726 can determine a current location using Wi-Fi or cellular location technology. For example, the location of the mobile device can be estimated using knowledge of nearby cell sites and/or Wi-Fi access points with knowledge also of their locations. Information identifying the Wi-Fi or cellular transmitter is received at wireless circuitry 708 and is passed to location/motion module 726. In some embodiments, the location module receives the one or more transmitter IDs. In some embodiments, a sequence of transmitter IDs can be compared with a reference database (e.g., Cell ID database, Wi-Fi reference database) that maps or correlates the transmitter IDs to position coordinates of corresponding transmitters, and computes estimated position coordinates for device 700 based on the position coordinates of the corresponding transmitters. Regardless of the specific location technology used, location/motion module 726 receives information from which a location fix can be derived, interprets that information, and returns location information, such as geographic coordinates, latitude/longitude, or other location fix data.

The one or more applications 728 on device 700 can include any applications installed on the device 700, including without limitation, a photo application (e.g., photo application 100) a browser, address book, contact list, email, instant messaging, social networking, word processing, keyboard emulation, widgets, JAVA-enabled applications, encryption, digital rights management, voice recognition, voice replication, a music player (which plays back recorded music stored in one or more files, such as MP3 or AAC files), etc.

There may be other modules or sets of instructions (not shown), such as a graphics module, a time module, etc. For example, the graphics module can include various conventional software components for rendering, animating and displaying graphical objects (including without limitation text, web pages, icons, digital images, animations and the like) on a display surface. In another example, a timer module can be a software timer. The timer module can also be implemented in hardware. The time module can maintain various timers for any number of events.

I/O subsystem 706 can be coupled to a display system (not shown), which can be a touch-sensitive display. The display displays visual output to the user in a GUI. The visual output can include text, graphics, video, and any combination thereof. Some or all of the visual output can correspond to user-interface objects. A display can use LED (light emitting diode), LCD (liquid crystal display) technology, or LPD (light emitting polymer display) technology, although other display technologies can be used in other embodiments.

In some embodiments, I/O subsystem 706 can include a display and user input devices such as a keyboard, mouse, and/or trackpad. In some embodiments, I/O subsystem 706 can include a touch-sensitive display. A touch-sensitive display can also accept input from the user based at least part on haptic and/or tactile contact. In some embodiments, a touch-sensitive display forms a touch-sensitive surface that accepts user input. The touch-sensitive display/surface (along with any associated modules and/or sets of instructions in computer-readable medium 702) detects contact (and any movement or release of the contact) on the touch-sensitive display and converts the detected contact into interaction with user-interface objects, such as one or more soft keys, that are displayed on the touch screen when the contact occurs. In some embodiments, a point of contact between the touch-sensitive display and the user corresponds to one or more digits of the user. The user can make contact with the touch-sensitive display using any suitable object or appendage, such as a stylus, pen, finger, and so forth. A touch-sensitive display surface can detect contact and any movement or release thereof using any suitable touch sensitivity technologies, including capacitive, resistive, infrared, and surface acoustic wave technologies, as well as other proximity sensor arrays or other elements for determining one or more points of contact with the touch-sensitive display.

Further, I/O subsystem 706 can be coupled to one or more other physical control devices (not shown), such as pushbuttons, keys, switches, rocker buttons, dials, slider switches, sticks, LEDs, etc., for controlling or performing various functions, such as power control, speaker volume control, ring tone loudness, keyboard input, scrolling, hold, menu, screen lock, clearing and ending communications and the like. In some embodiments, in addition to the touch screen, device 700 can include a touchpad (not shown) for activating or deactivating particular functions. In some embodiments, the touchpad is a touch-sensitive area of the device that, unlike the touch screen, does not display visual output. The touchpad can be a touch-sensitive surface that is separate from the touch-sensitive display or an extension of the touch-sensitive surface formed by the touch-sensitive display.

In some embodiments, some or all of the operations described herein can be performed using an application executing on the user's device. Circuits, logic modules, processors, and/or other components may be configured to perform various operations described herein. Those skilled in the art will appreciate that, depending on implementation, such configuration can be accomplished through design, setup, interconnection, and/or programming of the particular components and that, again depending on implementation, a configured component might or might not be reconfigurable for a different operation. For example, a programmable processor can be configured by providing suitable executable code; a dedicated logic circuit can be configured by suitably connecting logic gates and other circuit elements; and so on.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium, such as a compact disk (CD) or DVD (digital versatile disk), flash memory, and the like. The computer readable medium may be any combination of such storage or transmission devices.

Computer programs incorporating various features of the present disclosure may be encoded on various computer readable storage media; suitable media include magnetic disk or tape, optical storage media, such as compact disk (CD) or DVD (digital versatile disk), flash memory, and the like. Computer readable storage media encoded with the program code may be packaged with a compatible device or provided separately from other devices. In addition, program code may be encoded and transmitted via wired optical, and/or wireless networks conforming to a variety of protocols, including the Internet, thereby allowing distribution, e.g., via Internet download. Any such computer readable medium may reside on or within a single computer product (e.g. a solid state drive, a hard drive, a CD, or an entire computer system), and may be present on or within different computer products within a system or network. A computer system may include a monitor, printer, or other suitable display for providing any of the results mentioned herein to a user.

As described above, one aspect of the present technology is the gathering, sharing, and use of data, including an authentication tag and data from which the tag is derived. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to authenticate another device, and vice versa to control which devices ranging operations may be performed. Further, other uses for personal information data that benefit the user are also contemplated by the present disclosure. For instance, health and fitness data may be shared to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of sharing content and performing ranging, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

Although the present disclosure has been described with respect to specific embodiments, it will be appreciated that the disclosure is intended to cover all modifications and equivalents within the scope of the following claims.

All patents, patent applications, publications, and descriptions mentioned herein are incorporated by reference in their entirety for all purposes. None is admitted to be prior art.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. The phrase “based on” should be understood to be open-ended, and not limiting in any way, and is intended to be interpreted or otherwise read as “based at least in part on,” where appropriate. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure. The use of “or” is intended to mean an “inclusive or,” and not an “exclusive or” unless specifically indicated to the contrary. Reference to a “first” component does not necessarily require that a second component be provided. Moreover reference to a “first” or a “second” component does not limit the referenced component to a particular location unless expressly stated. The term “based on” is intended to mean “based at least in part on.”

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, and/or components.

Implementations within the scope of the present disclosure include a computer-readable storage medium that encodes instructions organized as an application that, when executed by one or more processing units, control an electronic device to perform any of the methods described herein.

It should be recognized that the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, the application is an application that is pre-installed on device at purchase (e.g., a first party application). In other embodiments, the application is an application that is provided to the device via an operating system update file (e.g., a first party application or a second party application). In other embodiments, the application is an application that is provided via an application store. In some embodiments, the application store can be an application store that is pre-installed on the device at purchase (e.g., a first party application store). In other embodiments, the application store is a third-party application store (e.g., an application store that is provided by another application store, downloaded via a network, and/or read from a storage device).

What is claimed is:

1. A method comprising:
receiving, by an application of a user device, a query associated with a corpus of image files, wherein each image file comprises metadata and an embedding, and wherein the embedding represents one or more visual characteristics of the image file;
generating, by the application of the user device, a first feature vector for at least a portion of the query, the first feature vector representing one or more textual characteristics of the query;
providing, by the application of the user device, the first feature vector as input to a query understanding model that is trained to semantically parse the first feature vector to identify at least one of one or more entities, one or more locations, one or more actions, or a timeframe;
producing, by the application of the user device, a revised query from the query by removing the one or more locations and the timeframe from the query;
generating, by the application of the user device, a second feature vector for the revised query;
providing, by the application of the user device, the second feature vector as input to a semantic search model that is trained to compare the second feature vector and the embedding for each image file in the corpus of image files to identify one or more preliminary image files of the corpus of image files; and
receiving, by the application of the user device, the one or more preliminary image files as output from the semantic search model.

2. The method of claim 1, wherein providing the first feature vector as input to the query understanding model further comprises:
classifying, by the application of the user device, the first feature vector as a plain language query or a semantic query; and
responsive to classifying the first feature vector as the semantic query, providing, by the application of the user device, the first feature vector as input to the query understanding model.

3. The method of claim 1, wherein producing the revised query comprises:
comparing, by the application of the user device, each of the one or more entities to a list of unique identifiers to determine one or more matching entities, where a matching entity corresponds to a unique identifier in the list of unique identifiers; and
replacing, by the application of the user device, the one or more matching entities with one or more unique identifiers and removing the one or more locations and the timeframe from the query to produce the revised query.

4. The method of claim 1, further comprising:
comparing, by the application of the user device, the one or more locations and the timeframe from the query to the metadata for each of the one or more preliminary image files to identify one or more matching image files; and
presenting, by the application of the user device, at least one of the one or more matching image files on a display of the user device.

5. The method of claim 4, wherein the one or more matching image files comprise the one or more preliminary image files with metadata that matches at least a location of the one or more locations or the timeframe.

6. The method of claim 5, wherein comparing the one or more locations to the metadata of a preliminary image file comprises:
identifying one or more distances, each of the one or more distances comprising a distance between the one or more locations and a metadata location from the metadata;
identifying at least one distance of the one or more distances with a magnitude that is less than a distance threshold; and
classifying the preliminary image file as a matching image file in response to the magnitude being less than the distance threshold.

7. The method of claim 5, wherein comparing the timeframe to the metadata of a preliminary image file comprises:
identifying a temporal distance comprising a difference between the timeframe and a metadata timeframe from the metadata of the preliminary image file;
determining that the temporal distance exceeds a temporal threshold; and
classifying the preliminary image file as a matching image file in response to the temporal distance exceeding the temporal threshold.

8. A computing device, comprising:
one or more memories; and
one or more processors in communication with the one or more memories and configured to execute instructions stored in the one or more memories to performing operations to:
receive, by an application of the computing device, a query associated with a corpus of image files, wherein each image file comprises metadata and an embedding, and wherein the embedding represents one or more visual characteristics of the image file;
generate, by the application of the computing device, a first feature vector for at least a portion of the query, the first feature vector representing one or more textual characteristics of the query;
provide, by the application of the computing device, the first feature vector as input to a query understanding model that is trained to semantically parse the first feature vector to identify at least one of one or more entities, one or more locations, one or more actions, or a timeframe;
produce, by the application of the computing device, a revised query from the query by removing the one or more locations and the timeframe from the query;
generate, by the application of the computing device, a second feature vector for the revised query;
provide, by the application of the computing device, the second feature vector as input to a semantic search model that is trained to compare the second feature vector and the embedding for each image file in the corpus of image files to identify one or more preliminary image files of the corpus of image files; and
receive, by the application of the computing device, the one or more preliminary image files as output from the semantic search model.

9. The computing device of claim 8, wherein providing the first feature vector as input to the query understanding model further comprises operations to:
classify, by the application of the computing device, the first feature vector as a plain language query or a semantic query; and
responsive to classifying the first feature vector as the semantic query, provide, by the application of the computing device, the first feature vector as input to the query understanding model.

10. The computing device of claim 8, wherein producing the revised query comprises operations to:
compare, by the application of the computing device, each of the one or more entities to a list of unique identifiers to determine one or more matching entities, where a matching entity corresponds to a unique identifier in the list of unique identifiers; and
replace, by the application of the computing device, the one or more matching entities with one or more unique identifiers and removing the one or more locations and the timeframe from the query to produce the revised query.

11. The computing device of claim 8, wherein the operations further comprise operations to:
compare, by the application of the computing device, the one or more locations and the timeframe from the query to the metadata for each of the one or more preliminary image files to identify one or more matching image files; and
present, by the application of the computing device, at least one of the one or more matching image files on a display of the computing device.

12. The computing device of claim 11, wherein the one or more matching image files comprise the one or more preliminary image files with metadata that matches at least a location of the one or more locations or the timeframe.

13. The computing device of claim 12, wherein comparing the one or more locations to the metadata of a preliminary image file comprises operations to:
identify one or more distances, each of the one or more distances comprising a distance between the one or more locations and a metadata location from the metadata;
identify at least one distance of the one or more distances with a magnitude that is less than a distance threshold; and
classify the preliminary image file as a matching image file in response to the magnitude being less than the distance threshold.

14. The computing device of claim 12, wherein comparing the timeframe to the metadata of a preliminary image file comprises operations to:
identify a temporal distance comprising a difference between the timeframe and a metadata timeframe from the metadata;
determine that the temporal distance exceeds a temporal threshold; and
classify the preliminary image file as a matching image file in response to the temporal distance exceeding the temporal threshold.

15. A non-transitory computer-readable medium storing a plurality of instructions that, when executed by one or more processors of a computing device, cause the one or more processors to perform operations to:
receive, by an application of the computing device, a query associated with a corpus of image files, wherein each image file comprises metadata and an embedding, and wherein the embedding represents one or more visual characteristics of the image file;
generate, by the application of the computing device, a first feature vector for at least a portion of the query, the first feature vector representing one or more textual characteristics of the query;
provide, by the application of the computing device, the first feature vector as input to a query understanding model that is trained to semantically parse the first feature vector to identify at least one of one or more entities, one or more locations, one or more actions, or a timeframe;
produce, by the application of the computing device, a revised query from the query by removing the one or more locations and the timeframe from the query;
generate, by the application of the computing device, a second feature vector for the revised query;
provide, by the application of the computing device, the second feature vector as input to a semantic search model that is trained to compare the second feature vector and the embedding for each image file in the corpus of image files to identify one or more preliminary image files of the corpus of image files; and
receive, by the application of the computing device, the one or more preliminary image files as output from the semantic search model.

16. The non-transitory computer-readable medium of claim 15, wherein providing the first feature vector as input to the query understanding model further comprises operations to:
classify, by the application of the computing device, the first feature vector as a plain language query or a semantic query; and
responsive to classifying the first feature vector as the semantic query, provide, by the application of the computing device, the first feature vector as input to the query understanding model.

17. The non-transitory computer-readable medium of claim 15, wherein producing the revised query comprises operations to:
compare, by the application of the computing device, each of the one or more entities to a list of unique identifiers to determine one or more matching entities, where a matching entity corresponds to a unique identifier in the list of unique identifiers; and
replace, by the application of the computing device, the one or more matching entities with one or more unique identifiers and removing the one or more locations and the timeframe from the query to produce the revised query.

18. The non-transitory computer-readable medium of claim 15, wherein the operations further comprise operations to:
compare, by the application of the computing device, the one or more locations and the timeframe from the query to the metadata for each of the one or more preliminary image files to identify one or more matching image files; and
present, by the application of the computing device, at least one of the one or more matching image files on a display of the computing device.

19. The non-transitory computer-readable medium of claim 18, wherein the one or more matching image files comprise the one or more preliminary image files with metadata that matches at least a location of the one or more locations or the timeframe.

20. The non-transitory computer-readable medium of claim 19, wherein comparing the one or more locations to the metadata of a preliminary image file comprises operations to:
identify one or more distances, each of the one or more distances comprising a distance between the one or more locations and a metadata location from the metadata;
identify at least one distance of the one or more distances with a magnitude that is less than a distance threshold; and
classify the preliminary image file as a matching image file in response to the magnitude being less than the distance threshold.
